(19) United States
(12) Patent Application Publication
(10) Pub. No.: US 2007/0263977 A1
(43) Pub. Date: Nov. 15, 2007

(54) IMAGE PROCESSING APPARATUS

(75) Inventor: Yasuaki KAMIYA, Iwata-shi (JP)

Correspondence Address: ROSSI, KIMMS & McDOWELL LLP., P.O. BOX 826, ASHBURN, VA, 20146-0826, US

(73) Assignee: YAMAHA CORPORATION, Hamamatsu-shi (JP)

(21) Appl. No.: 11/739,683

(22) Filed: Apr. 24, 2007

(30) Foreign Application Priority Data
Apr. 28, 2006 (JP) 2006-126381

(51) Int. Cl. H04N 5/91

(52) U.S. Cl. 386/46

(57) ABSTRACT

An image processing apparatus reads image data written in a video memory, performs an expansion or reduction process of the image data by filter computation, and sequentially outputs the image data to a display device in synchronization with a display clock. In the image processing apparatus, a primary buffer stores the image data read from the video memory. A first computing unit performs a first filter computation of the image data read from the primary buffer in synchronization with the display clock. A secondary buffer stores the image data outputted from the first computing unit. A second computing unit performs a second filter computation of the image data outputted from the secondary buffer in synchronization with the display clock, so that the image data is expanded or reduced in real time basis by a sequence of the first filter computation and the second filter computation.

### BACKGROUND OF THE INVENTION

1. Technical Field

The present invention relates to an image processing apparatus that captures, in real time, a video signal in NTSC format, PAL format or the like, and then supplies the video signal by superimposing thereon an OSD image or the like, to a display device or the like.

2. Related Art

Recently, some apparatuses have been developed which capture video signals in NTSC format, PAL format or the like, taken by a video camera or transmitted by broadcasting, as image data, and which display the image data on a display screen by expanding or reducing the same in real time. These apparatuses superimpose an OSD image composed of characters, graphics, or the like on the captured image data, and supply the image data to a display device. This type of apparatuses have image data processing circuits (display planes) constructed by means of a plurality of hardware, and the display planes are used to convert the capture image data, image data created by a CPU, back image data and the like to display data, and display them according to a predetermined priority. Such a prior art is disclosed for example by the following patent documents: Japanese Unexamined Patent Publication No. 2005-257886; Japanese Unexamined Patent Publication No. 2004-147285; and Japanese Unexamined Patent Publication No. 2005-215252.

Meanwhile, in the expansion/reduction process of image data, it is necessary to generate color data of dots not contained in the image data by the video capture, by interpolation computation from the color data of the respective dots of the capture image data. Conventionally, since the data processing time is extremely short when the image data by the video capture are expanded or reduced in real time, it is only possible to adopt a relatively simple process such as a nearest neighbor process (the use of color data of a dot locating at the nearest distance) or the like, but it is not possible to adopt a high performance expansion/reduction process.

### SUMMARY OF THE INVENTION

The present invention has been achieved in consideration of the forgoing circumstances, and has for its object to provide an image processing apparatus capable of performing an expansion/reduction process of image data in an extremely short time, thereby enabling high performance expansion/reduction process of capture image data in real time.

This invention has been made to achieve the above object, and the inventive image processing apparatus reads image data written in a video memory, performs an expansion or reduction process of the image data by filter computation, and sequentially outputs the image data to a display device in synchronization with a display clock. The inventive image processing apparatus comprises: a primary buffer in which the image data read from the video memory are written; a first computing unit that performs a first filter computation of the image data read from the primary buffer in synchronization with the display clock; a secondary buffer in which the image data outputted from the first computing unit are written; and a second computing unit that performs a second filter computation of the image data outputted from the secondary buffer in synchronization with the display clock, so that the image data is expanded or reduced in real time basis by a sequence of the first filter computation and the second filter computation.

Preferably in the image processing apparatus, the first computing unit is provided with a first memory section that stores a plurality of filter coefficient sets in advance, and performs the first filter computation by reading one filter coefficient set among the plurality of the filter coefficient sets from the first memory section based on an expansion or reduction ratio of the expansion or reduction process, and by using the read filter coefficient set for performing the first filter computation.

Further, the second computing unit is provided with a second memory section that stores a plurality of filter coefficient sets in advance, and performs the second filter computation by reading one filter coefficient set among the plurality of the filter coefficient sets from the second memory section based on an expansion or reduction ratio of the expansion or reduction process, and by using the read filter coefficient set for performing the second filter computation.

Preferably, the first computing unit performs the first filter computation using an FIR filter, and the second computing unit performs the second filter computation using an FIR filter.

Preferably, the primary buffer is formed from at least four memories, such that the image data are outputted concurrently from the four memories in synchronization with the display clock.

Further, the secondary buffer is formed from two memories, such that writing of the image data outputted from the first computing unit and reading of the image data to the second computing unit are performed alternately between the two memories.

Preferably, the video memory stores the image data representing color data allocated to an array of dots arranged in rows and columns. The first computing unit performs the first filter computation such as to interpolate color data for one row of the dots after expansion or reduction process based on color data of a plurality of selected rows which are adjacent to said one row before expansion or reduction process, and the second computing unit performs the second filter computation such as to interpolate color data of one dot after expansion or reduction process based on color data of a plurality of dots which are adjacent to said one dot and which are selected from said one row of the dots.

Further, the inventive processing apparatus comprises a controller that controls the reading and writing of contents of the primary buffer such that the primary buffer is written with color data of the plurality of the selected rows when the first computing unit performs the first filter computation of said one row. The controller is operative when the first computing unit performs the first filter computation of another row which is next to said one row, for determining whether or not to update the contents of the primary buffer based on an expansion ratio of the expansion process and a position of said another row relative to said one raw.

In accordance with this invention, there are the effects that the expansion/reduction process of image data can be performed in an extremely short time, whereby the high performance expansion/reduction process of capture image data can be performed in real time, thereby achieving display with superior image quality.

### BRIEF DESCRIPTION OF THE DRAWINGS

FIG. 1 is a block diagram showing the configuration of an image processing apparatus according to an embodiment of the present invention.

FIG. 2 is a block diagram showing the configuration of a CPC in the image processing apparatus.

FIG. 3 is a block diagram showing the configurations of filters in the CPC.

FIG. 4 is an explanatory diagram for explaining the operation of the CPC.

FIG. 5 is an explanatory diagram for explaining the operation of the CPC.

FIG. 6 is a diagram showing an example of filter coefficients set to the filter.

FIG. 7 is a diagram showing an example of filter coefficients set to the filter.

FIG. 8 is an explanatory diagram for explaining the operation of the CPC.

FIG. 9 is a timing chart for explaining the operation of the CPC.

FIG. 10 is a diagram for explaining the operation of the CPC, and showing image data written in a primary buffer and a secondary buffer.

### DETAILED DESCRIPTION OF THE INVENTION

An embodiment of the present invention will be described below with reference to the drawings.

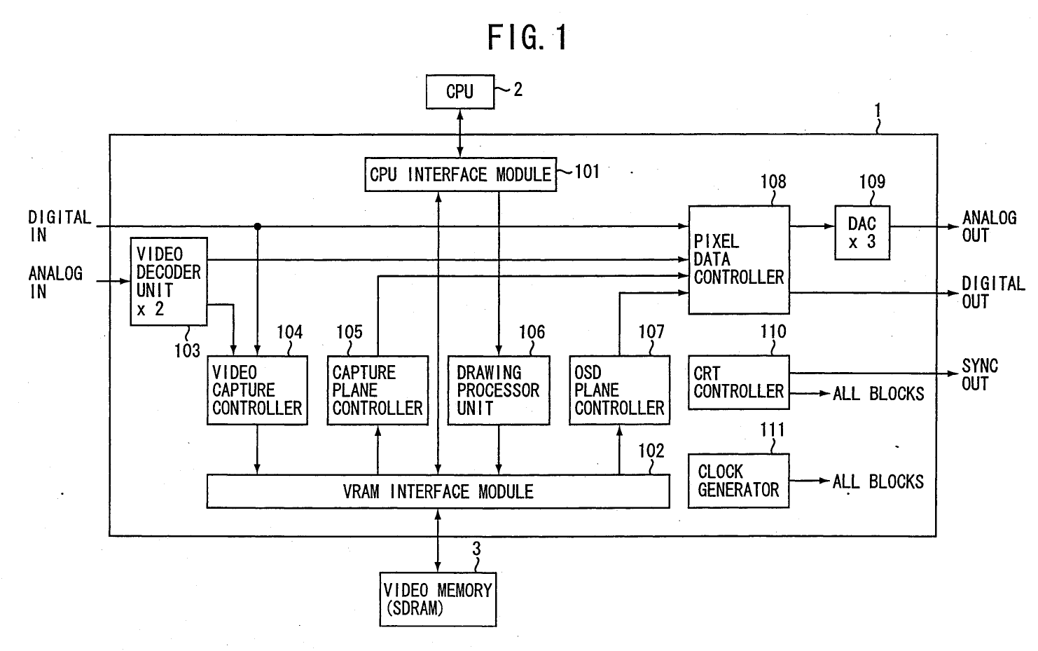

FIG. 1 is a block diagram showing the configuration of a VDP (Video Display Processor; an image processing apparatus) according to an embodiment of the present invention. In FIG. 1, the VDP 1 captures an image input and writes the image input as image data in a video memory 3, and thereafter directs a CRT display device (not shown) to display the image at a given display resolution. The VDP 1 also has a function of inputting a drawing command from a CPU (Central Processing Unit) 2, and performing an OSD (On Screen Display) display to a video input. In another form, an LCD (liquid Crystal Display) or other display device may be used as a monitor instead of the CRT display device.

In the present embodiment, three kinds of commands consisting of LINE command, FILL command, and COPY command are used as the drawing command. The LINE command is a command to perform a linear drawing by designating an initial node and a terminal node, and the FILL command is a command to perform filling by designating a rectangular region. The COPY command is a command to perform copying of data in a video memory space by designating a source address and a destination address. The COPY command further includes information of designating a format conversion, and information of transparent color control and of setting a blending.

A CPU interface module 101 in the VDP 1 governs communications with the CPU 2, and has a function of outputting a drawing command inputted from the CPU 2 to a DPU 106, and a function of controlling access from the CPU 2 to the video memory 3. A VRAM interface module 102 controls access from each part within the VDP 1 to the video memory 3.

A VDU (Video Decoder Unit) 103 inputs an analog image signal and converts it to a digital image signal. A VCC (Video Capture Controller) 104 captures a digital image signal outputted from the VDU 103, or a digital image signal directly inputted from the exterior, and writes it as image data in the video memory 3. There are provided two decoder circuits of the VDU 103 and two capture circuits of the VCC 104, so that two channels of analog image signal inputs can be captured at the same time.

A CPC (Capture Plane Controller) 105 reads image data from the video memory 3, performs an expansion/reduction process, and outputs the data to a PDC 108. A DPU (Drawing Processor Unit) 106 interprets a drawing command inputted from the CPU interface module 101, and draws a line or a rectangle in the video memory 3, and performs a predetermined process to the drawn data. The CPU 2 can also directly draw in the video memory 3 without using the drawing command.

An OSD plane controller 107 reads data to be displayed as an OSD image, from a video memory 8, and outputs the data to the PDC 108. The PDC (Pixel Data Controller) 108 directs a back drop plane to directly display image inputs, namely, an image based on the digital image signal inputted from the exterior, and an image based on the digital image signal after being decoded by the VDU 103. It also inputs capture image data outputted from the CPC 105, and data for displaying as an OSD image outputted from the OSD plane controller 107, and unifies the formats of the respective planes, and performs synthesis process based on the priority of display and the setting of α blending, or the like.

The VDP 1 enables hierarchy display by means of a back drop plane and four display planes consisting of the back drop plane for displaying an image inputted from the exterior, two display planes for displaying capture image data and two display planes for displaying an OSD image. The PDC 108 performs synthesis process of the four display planes and the back drop plane.

The term “display plane” indicates one containing all the necessary configurations for displaying a single rectangular image data at a predetermined location of an external display device and at a predetermined size, or indicates display data themselves to be supplied to the external display device.

The PDC 108 directly outputs display data after synthesis to the outside as a digital image signal and outputs as is to the exterior, and also outputs it as an analog image signal via a DAC (Digital Analog Converter) 109. The CRT controller 110 outputs a timing signal used when displaying images on a CRT display device, and also outputs information related to monitor display to each part in the VDP 1. A clock generator 111 generates clocks used at individual parts in the VDP 1.

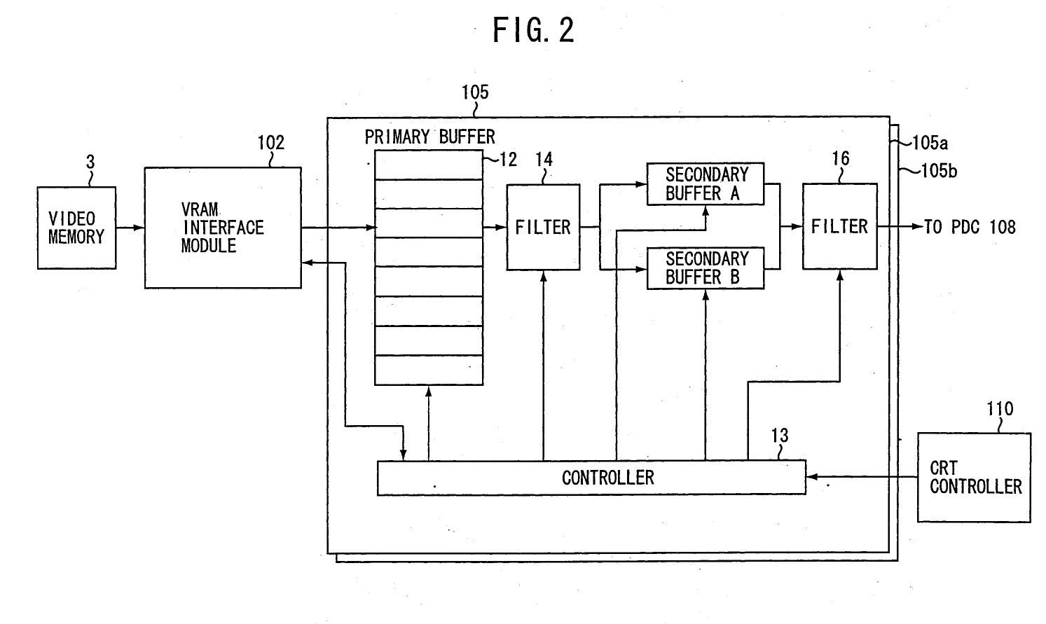

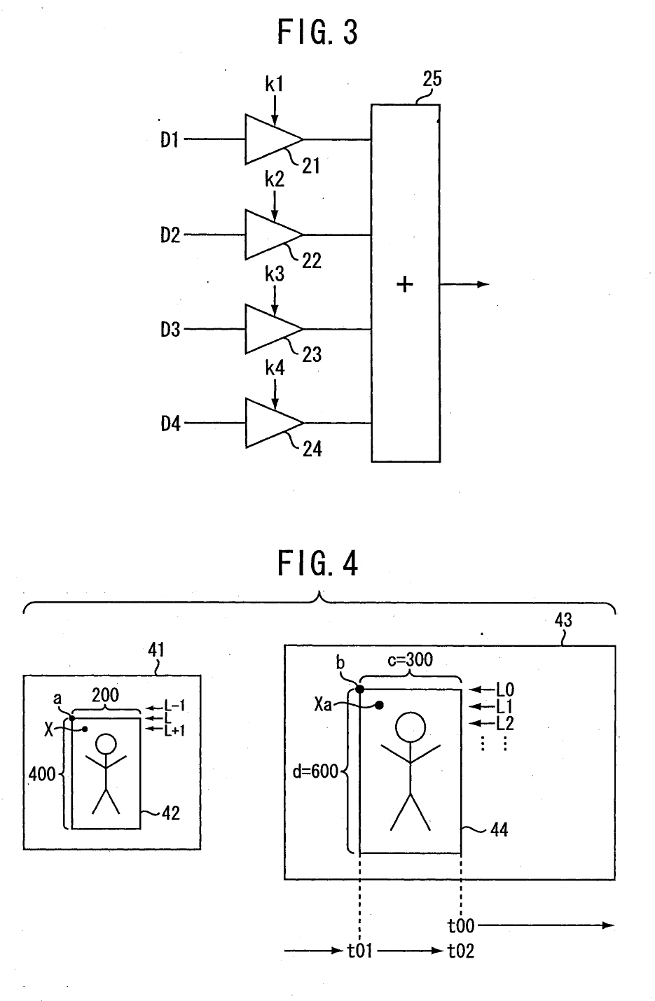

FIG. 2 is a block diagram showing the details of the CPC 105 in FIG. 1, in which the CPC 105 is formed from two display planes 105a and 105b having the same configuration. In the display plane 105a, reference number 12 designates a primary buffer in which image data outputted from the video memory 3 are written, the primary buffer operating as eight memories, wherein the outputs of four memories selected by a controller 13 are outputted to a filter 14. The filter 14 is an FIR filter and formed from multipliers 21 to 24, and an adder 25 that adds the outputs of the multipliers 21 to 24, as shown in FIG. 3. Multiplication coefficients k1 to k4 of the multipliers 21 to 24 are read from the video memory 3 and set by the controller 13. The output of the filter 14 is written in a secondary buffer A or a secondary buffer B.

The secondary buffers A and B operate under the control of the controller 13 such that when one of the secondary buffers A and B is subjected to writing, the other is subjected to reading, thus performing the writing and reading alternately. The outputs of the secondary buffers A and B are supplied to a filter 16. The filter 16 is an FIR filter of the same configuration as the filter 14 (refer to FIG. 3), and the output thereof is outputted to the PDC 108.

The operation of the above-mentioned display plane 105a will next be described.

Firstly, a basic concept of the expansion/reduction process will be described. Now, in FIG. 4, suppose that reference number 41 designates image data written in the video memory 3, reference number 42 designates image data to be expansion-displayed on a display device, reference number 43 designates a display screen of the display device, and reference number 44 designates an expansion-displayed image. At this time, the color data of a certain dot Xa within the image 44 can be obtained from color data of sixteen dots around a point X within the image data 42 corresponding to the dot Xa.

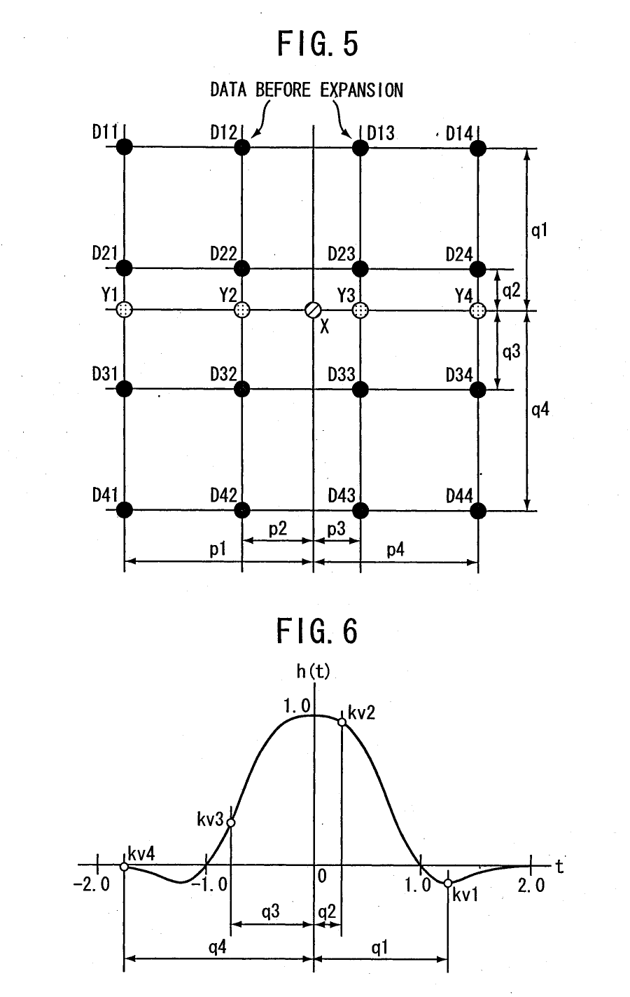

Specifically, in FIG. 5, it is supposed that sixteen dots around the point X are dots D11 to D44, and it is considered that a virtual dot is located at an intersection Y1 between a line extending horizontally from the point X and a line formed by a row of the dots D11 to D41, and that the color data of the virtual dot are obtained from the color data of the dots D11 to D41. Similarly, the color data of, a virtual dot at an intersection Y2 between the line extending horizontally from the point X and a line formed by a row of the dots D12 to D42, a virtual dot at an intersection Y3 between the line extending horizontally from the point X and a line formed by a row of the dots D13 to D43, and a virtual dot at an intersection Y4 between the line extending horizontally from the point X and a line formed by a row of the dots D14 to D44, are obtained from the color data of the dots D12 to D42, the color data of the dots D13 to D43, and the color data of the dots D14 to D44, respectively. Then, the color data of the point X is obtained from the color data of the points Y1 to Y4.

The color data of the points Y1 to Y4 can be obtained from the following filter computing equations.
Y1=kv1·D11+kv2·D21+kv3·D31+kv4·D41
Y2=kv1·D12+kv2·D22+kv3·D32+kv4·D42
Y3=kv1·D13+kv2·D23+kv3·D33+kv4·D43
Y4=kv1·D14+kv2·D24+kv3·D34+kv4·D44
where filter coefficients kv1 to kv4 are coefficients determined by distances q1 to q4 between the point Y1 and the dots D11 to D41, respectively (refer to FIG. 5), and there can be used, for example, the values on the graph shown in FIG. 6. The color of the point Y1 will be changed by the method of determining these coefficients. The filter 14 performs the above filter computations. As described above, the filter coefficients are provided in advance in the video memory 3, and these are read and set to the filter 14 by the controller 13.

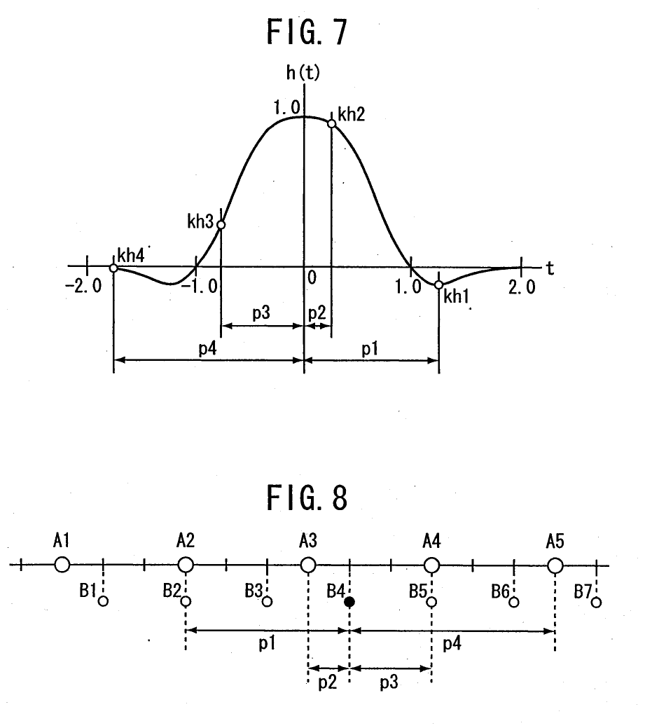

Next, the color data of the point X can be obtained from the color data of the points Y1 to Y4 by using the following filter computing equation.
X=kh1·Y1+kh2·Y2+kh3·Y3+kh4·Y4
where filter coefficients kh1 to kh4 are coefficients determined by distances p1 to p4 between the point X and the points Y1 to Y4, respectively (refer to FIG. 5), and there can be used, for example, the values on the graph shown in FIG. 7. The color of the point X will be adjusted by the method of determining these coefficients. The filter 16 performs the above filter computation. The filter coefficients are provided in advance in the video memory 3, and these are read and set to the filter 16 by the controller 13.

As described above, the video memory 3 stores the image data representing color data allocated to an array of dots arranged in rows and columns. A first computing unit includes the filter 14 for performing a vertical filter computation such as to interpolate color data for one row of the dots after expansion or reduction process based on color data of four rows of dots D11 through D44 which are adjacent to said one row of dots Y1 through Y4 before expansion or reduction process. A second computing unit includes the filter 16 for performing a horizontal filter computation such as to interpolate color data of one dot after expansion or reduction process based on color data of four dots Y1 through Y4 which are adjacent to said one dot X and which are selected from said one row of the dots.

The relationship between the above-mentioned filter coefficients and the point X will next be described.

Consider, for example, the case of expanding the image at 1.5 magnifications in the horizontal direction. In this case, the controller 13 is given the followings from the exterior.
Up sample number=3
Down sample number=2
   FIG. 8 is a diagram for explaining the up sample number and the down sample number, in which A1 to A5 indicate dots before expansion, and B1 to B7 indicate dots after expansion. As shown in this figure, the up sample number “3” is a number by which the interval between the dots before expansion is divided into sub-intervals, and the down sample number “2” is a number of sub-intervals apart which points after expansion are arranged. As apparent from the figure, the points after expansion are present only at ends of sub-intervals divided by the up sample number, and therefore the filter coefficients corresponding to the respective end of sub-intervals may be provided in advance in the video memory 3. The controller 13 also detects to which end of sub-intervals a display dot corresponds, from the order of the dots after expansion, and sets the corresponding filter coefficients to the filter 14 and the filter 16.

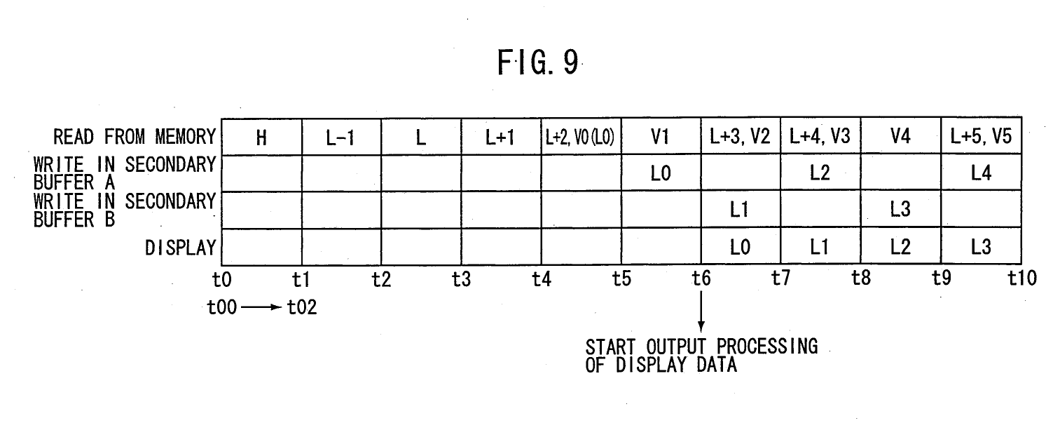

The operation of the image processing apparatus 2 shown in FIG. 2 will next be described with reference to FIG. 9. FIG. 9 is a timing chart showing, based on the timing of horizontal scanning of the display device, which type of data are read from the video memory 3, and which type of data are written in the secondary buffers A and B, and which type of data are outputted for display from the filter 16, with an elapse of time. One period (one scale on the abscissa) in FIG. 9 corresponds to time t00 to t02 in FIG. 4. That is, for example, the time t0 in FIG. 9 is a point immediately after a horizontal scanning has passed through the dot of the rightmost end of an expanded image, and the time t1 is a point immediately after the next horizontal scanning has passed through the dot of the rightmost end of the expanded image. Specifically, the t0 to t1 correspond to the scanning time of one line. This is true for other periods t1 to t2, t2 to t3, . . . .

When the image processing apparatus 2 performs, for example, an expansion process shown in FIG. 4, the controller 13 receives the following data from the outside, and causes the internal memory to store the data (refer to FIG. 4).
a=Storage position within the video memory 3 of the dot of the upper left-hand corner of the image before expansion;
b=Display position on the display screen 43 of the dot of the upper left-hand corner of the image after expansion;
c=Number of horizontal dots of the image after expansion;
d=Vertical dot number of the image after expansion;
e=Up sample number
f=Down sample number

It is supposed that the vertical filter coefficients V and the horizontal filter coefficients H, which correspond to the up sample number e and the down sample number f, respectively, are set in advance in the video memory 3. If the vertical expansion ratio and the horizontal expansion ratio are different, up sample numbers and down sample numbers which will vary with regard to the vertical direction and the horizontal direction are inputted to the controller 13.

Upon the receipt of the above-mentioned respective data, the controller 13 reads all the horizontal filter coefficients H from the video memory 3 and set them in the internal memory at a period of t0-t1 (FIG. 9) being six periods ahead of the period that display data are to be outputted from the filter 16. Then, at the next period of t1-t2, the controller 13 reads from the video memory 3 the image data of the dot line L−1 immediately above the zero-th dot line L of the image before expansion (the uppermost dot line, refer to FIG. 4), and sets this image data to the primary buffer 12. This is because the color data of the dots of a still upper line L−1 from the zero-th dot line L of the image before expansion are required to obtain the color data of the zero-th dot line L0 of the image after expansion (FIG. 4).

Next, at a period of t2-t3, the controller 13 reads from the video memory 3 the image data of the zero-th dot line L of the image before expansion, and sets this data to the primary buffer 12. Next, at a period of t3-t4, it reads from the video memory 3 the image data of the first dot line L+1 of the image before expansion, and sets this data to the primary buffer 12. Next, at a period of t4-t5, it reads from the video memory 3 the image data of the second dot line L+2 of the image before expansion, and sets this data to the primary buffer 12, and it then reads from the video memory 3 a vertical filter coefficient V0 used for computing the color data of the zero-th dot line L0 of the image after expansion, and temporarily stores this data in the internal memory.

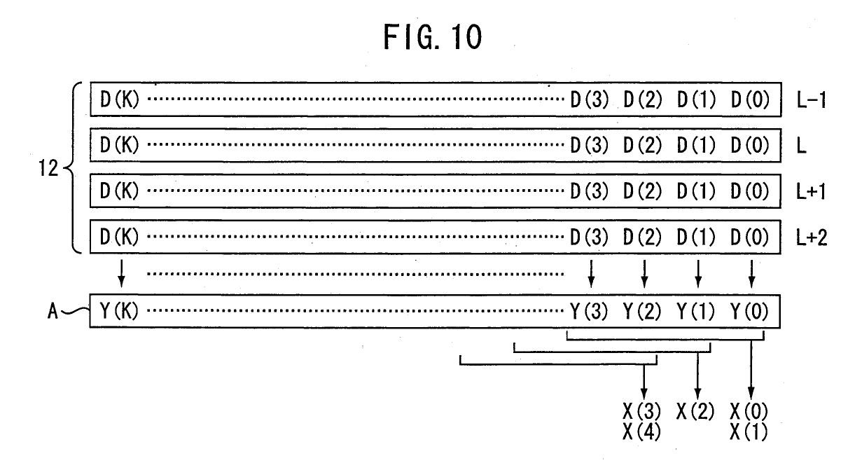

Next, at a period of t5-t6, the controller 13 reads from the video memory 3 a vertical filter coefficient V1 used for computing the color data of the first dot line L1 of the image after expansion, and temporarily stores this data in the internal memory. At the same period of t5-t6, the controller 13 also sets the vertical filter coefficient V0 stored in the internal memory to the filter 14 and reads in sequence the image data within the primary buffer 12 (the color data of the dots of the dot lines L−1, L, L+1, and L+2) and outputs them to the filter 14 at the timing of a display clock. The term “display clock” means a clock pulse to be generated at the clock generator 111 (FIG. 1), and the clock pulse that determines the timing of the dot display in the horizontal scanning of the display device. The color data outputted from the primary buffer 12 can be computed by the filter 14, whereby Y data for generating the color data of the zero-th line L0 of the image after expansion (refer to Y1 to Y4 in FIG. 5) are generated, and the generated respective Y data are written in sequence in the secondary buffer A at the timing of the display clock. FIG. 10 is an explanatory drawing of the procedure of the foregoing processes.

In the vertical expansion at 1.5 magnifications as shown in FIG. 4, when q2/q3 in FIG. 5 is smaller than ½, the data for computing the Y data of the first dot line L1 of the image after expansion can be computed from the image data within the primary buffer (the color data of the dots of the dot lines L−1, L, L+1, and L+2), and hence at the period of t5-t6, the image data of the third dot line L+3 of the image before expansion need not be set to the primary buffer 12. Namely, the Y data of the dot line L0 and the Y data of next dot line L1 after expansion can be computed by vertical interpolation using the same color data of the dot lines L−1, L, L+1, and L+2 before expansion, because the dot line L0 falls between the dot lines L and L+1, and the next dot line L1 still falls between the dot lines L and L+1. Therefore, it is not necessary to update the contents of the primary buffer 12 during the vertical interpolation for the dot lines L0 and L1.

Next, at a period of t6-t7, the controller 13 reads from the video memory 3 the image data of the third dot line L+3 of the image before expansion, and sets this data to the primary buffer 12, and thereafter reads from the video memory 3 a vertical filter coefficient V2 used for computing the color data of the second dot line L2 of the image after expansion, and temporarily stores this in the internal memory. At the same period of t6-t7, the controller 13 also outputs the color data of the dots (the dot lines L−1, L, L+1, and L+2) of the image data in the primary buffer 12 to the filter 14 at the timing of the display clock. The outputted color data can be computed by the filter 14, whereby the Y data for generating the color data of the first line L1 of the image after expansion are generated, and the generated respective Y data are written in sequence in the secondary buffer B at the timing of the display clock.

Further, at the same period of t6-t7, the controller 13 sets a horizontal filter coefficient H to the filter 16, and then outputs in sequence the Y data within the secondary buffer A to the filter 16 at the timing of the display clock. By the computation of the filter 16, the Y data inputted to the filter 16 are converted to the color data of the respective dots of the zero-th line after expansion (the point X in FIG. 5, refer to FIG. 10) and outputted to the PDC 108. In this case, the controller 13 selects the horizontal filter coefficient in accordance with the position of the dot to be computed, and sets it to the filter 16. The timing at which the first data are outputted from the secondary buffer A is determined based on the data b as previously described (refer to FIG. 4).

Although the timing at which the Y data of the secondary buffer A are outputted is in synchronization with the display clock of the display device, this does not mean that the data are outputted in sequence every clock. This is because color data of two or more dots may be occasionally computed by the same set of Y data. In this case, only the filter coefficient is changed, and the Y data remain unchanged, namely not updated.

Next, at a period of t7-t8, it reads from the video memory 3 the image data of a dot line L+4 on the fourth line of the image before expansion, and this data are then set to the primary buffer 12, and the vertical filter coefficient V3 is read from the video memory 3. Further, the Y data for computing the color data of the dot line L2 are written in sequence in the secondary buffer A at the timing of the display clock, and the Y data within the secondary buffer B are read in sequence at the timing of the display clock, and the color data of the respective dots of the first line after expansion are then outputted via the filter 16 to the PDC 108. Thus, the display of the dot line L1 can be carried out. Thereafter, a similar process is repeated.

As described above, in the vertical expansion at 1.5 magnifications, occasionally there is no need to read image data from the video memory 3 per horizontal scanning period. For example as shown in FIG. 9, there is no need of data reading for processing the dot lines L1, L4, . . . . This is because when q2/q3 in FIG. 5 is smaller than ½, the data for computing the Y data of the dot line L1 are the same as the data for computing the Y data of the dot line L0, and the data for computing the Y data of the dot line L4 are the same as the data for computing the Y data of the dot line L3. In the case of expansion, there is the advantage that the reading from the video memory 3 can be so omitted in part.

As described above, the controller 13 controls the reading and writing of contents of the primary buffer 12 such that the primary buffer 12 is written with color data of the plurality of the selected rows L−1, L, L+1 and L+2 when the first computing unit 14 performs the vertical filter computation of one row L0. Then, the controller 13 operates when the first computing unit 14 performs the vertical filter computation of another row L1 which is next to said one row L0, for determining whether or not to update the contents of the primary buffer 12 based on an expansion ratio of the expansion process and a position of said another row L1 relative to said one raw L0.

As described above, in the expansion process of the image data according to the invention, the image data for use in interpolation process of Y data can be commonly used for two or more of dot lines. Thus the controller 13 can occasionally skips reading of image data of new dot line from the video memory 3 at the horizontal scanning period, thereby performing the expansion process of the image data at fast speed and therefore enabling the high expansion performance of the capture data in real time basis.

In the case of reduction, by the computation of the filter 14, the Y data are generated and outputted to the filter 16, as in the case with the above-mentioned case of expansion. By the computation of the filter 16, the Y data inputted to the filter 16 are converted to the color data of the respective dots after reduction, and then outputted to the PDC 108.

This invention is applicable to display devices or the like which capture, in real time, the image signal in NTSC format, PAL format or the like, and display by superimposing thereon an OSD image or the like.

This image processing apparatus is used, for example, for monitoring a rear side of a vehicle invisible from a driver, with a video camera fixed to the rear of the vehicle, in combination with a display device mounted in the interior of the vehicle.

What is claimed is:

1. An image processing apparatus that reads image data written in a video memory, performs an expansion or reduction process of the image data by filter computation, and sequentially outputs the image data to a display device in synchronization with a display clock, wherein the image processing apparatus comprises:
a primary buffer in which the image data read from the video memory are written;
a first computing unit that performs a first filter computation of the image data read from the primary buffer in synchronization with the display clock;
a secondary buffer in which the image data outputted from the first computing unit are written; and
a second computing unit that performs a second filter computation of the image data outputted from the secondary buffer in synchronization with the display clock, so that the image data is expanded or reduced in real time basis by a sequence of the first filter computation and the second filter computation.

2. The image processing apparatus as set forth in claim 1, wherein the first computing unit is provided with a first memory section that stores a plurality of filter coefficient sets in advance, and performs the first filter computation by reading one filter coefficient set among the plurality of the filter coefficient sets from the first memory section based on an expansion or reduction ratio of the expansion or reduction process, and by using the read filter coefficient set for performing the first filter computation.

3. The image processing apparatus as set forth in claim 1, wherein the second computing unit is provided with a second memory section that stores a plurality of filter coefficient sets in advance, and performs the second filter computation by reading one filter coefficient set among the plurality of the filter coefficient sets from the second memory section based on an expansion or reduction ratio of the expansion or reduction process, and by using the read filter coefficient set for performing the second filter computation.

4. The image processing apparatus as set forth in claim 1, wherein the first computing unit performs the first filter computation using an FIR filter, and the second computing unit performs the second filter computation using an FIR filter.

5. The image processing apparatus as set forth in claim 1, wherein the primary buffer is formed from at least four memories, such that the image data are outputted concurrently from the four memories in synchronization with the display clock.

6. The image processing apparatus as set forth in claim 1, wherein the secondary buffer is formed from two memories, such that writing of the image data outputted from the first computing unit and reading of the image data to the second computing unit are performed alternately between the two memories.

7. The image processing apparatus as set forth in claim 1, wherein
the video memory stores the image data representing color data allocated to an array of dots arranged in rows and columns,
the first computing unit performs the first filter computation such as to interpolate color data for one row of the dots after expansion or reduction process based on color data of a plurality of selected rows which are adjacent to said one row before expansion or reduction process, and
the second computing unit performs the second filter computation such as to interpolate color data of one dot after expansion or reduction process based on color data of a plurality of dots which are adjacent to said one dot and which are selected from said one row of the dots.

8. The image processing apparatus as set forth in claim 7, further comprising a controller that controls the reading and writing of contents of the primary buffer such that the primary buffer is written with color data of the plurality of the selected rows when the first computing unit performs the first filter computation of said one row, the controller being operative when the first computing unit performs the first filter computation of another row which is next to said one row, for determining whether or not to update the contents of the primary buffer based on an expansion ratio of the expansion process and a position of said another row relative to said one raw.

9. An image processing method of reading image data written in a video memory, performing an expansion or reduction process of the image data by filter computation, and sequentially outputting the image data to a display device in synchronization with a display clock, wherein the image processing method comprises:
writing the image data read from the video memory into a primary buffer;
performing a first filter computation of the image data read from the primary buffer in synchronization with the display clock;
writing the image data outputted from the first computing unit into a secondary buffer; and
performing a second filter computation of the image data outputted from the secondary buffer in synchronization with the display clock, so that the image data is expanded or reduced in real time basis by a sequence of the first filter computation and the second filter computation.
